(19) United States
(12) Patent Application Publication
(10) Pub. No.: US 2023/0153504 A1
(43) Pub. Date: May 18, 2023

(54) PROCESSING PATH GENERATION METHOD, COMPUTER PROGRAMMING PRODUCT AND PROCESSING PATH GENERATION SYSTEM

(71) Applicant: Industrial Technology Research Institute, Hsinchu (TW)

(72) Inventors: Bei-Hua Yang, Pingtung County (TW); Yang-Lun Liu, New Taipei City (TW); Jen-Chieh Chang, Taichung City (TW)

(73) Assignee: Industrial Technology Research Institute, Hsinchu (TW)

(21) Appl. No.: 17/563,063

(22) Filed: Dec. 28, 2021

(30) Foreign Application Priority Data
Nov. 18, 2021 (TW) 110143060

(51) Int. Cl. G06F 30/392; G06F 30/394; G06F 30/398

(52) U.S. Cl. CPC G06F 30/392; G06F 30/394; G06F 30/398

(57) ABSTRACT

A processing path generation method, a computer programming product, and a processing path generation system are provided. The processing path generation method includes the following steps. A boundary of a processing area is obtained. The boundary of the processing area is equidistantly retracted at least once to obtain a plurality of first paths. The first paths are evenly distributed across the processing area. It is confirmed whether overlapping ones are present among the first paths, and if so, the overlapping ones are integrated into a second path. It is confirmed whether concentric closed loops are present among the first paths, and if so, the concentric closed loops are integrated in to a spiral third path. The second path and the third path are connected into a final path.

### CROSS-REFERENCE TO RELATED APPLICATION

This application claims the priority benefit of Taiwanese application no. 110143060, filed on Nov. 18, 2021. The entirety of the above-mentioned patent application is hereby incorporated by reference herein and made a part of this specification.

### BACKGROUND

### Technical Field

The disclosure relates to a path generation method, a computer programming product, and a path generation system, and in particular, relates to a processing path generation method, a computer programming product, and a processing path generation system.

### Description of Related Art

At present, a processing path generation method is manually planned most of the time through computer-aided design (CAD) software. As such, a lot of time and workforce are required to be consumed, and it is difficult to regularize and pass on the experiences and methods, so that the processing quality may not be easily controlled.

Besides, the computer-aided manufacturing (CAM) software available on the market only provides common path forms for metal processing, so the paths that meet the demand cannot be automatically generated and needs to be manually modified, and the production cycle is thereby increased.

### SUMMARY

The disclosure provides a processing path generation method, a computer programming product, and a processing path generation system capable of solving the problems caused by manual path planning.

The disclosure provides a processing path generation method, and the method includes the following steps. A boundary of a processing area is obtained. The boundary of the processing area is equidistantly retracted at least once to obtain a plurality of first paths. The first paths are evenly distributed across the processing area. It is confirmed whether overlapping ones are present among the first paths, and if so, the overlapping ones are integrated into a second path. It is confirmed whether concentric closed loops are present among the first paths, and if so, the concentric closed loops are integrated in to a spiral third path. The second path and the third path are connected into a final path.

The disclosure further provides a computer programming product, and after a program is loaded through a computer, the computer programming product is configured to perform the following steps. A boundary of a processing area is obtained. The boundary of the processing area is equidistantly retracted at least once to obtain a plurality of first paths. The first paths are evenly distributed across the processing area. It is confirmed whether overlapping ones are present among the first paths, and if so, the overlapping ones are integrated into a second path. It is confirmed whether concentric closed loops are present among the first paths, and if so, the concentric closed loops are integrated in to a spiral third path. The second path and the third path are connected into a final path.

The disclosure further provides a processing path generation system including a memory and a processor. The memory is configured to store a program. The processor is coupled to the memory and is configured to load the program to execute the following steps. A boundary of a processing area is obtained. The boundary of the processing area is equidistantly retracted at least once to obtain a plurality of first paths. The first paths are evenly distributed across the processing area. It is confirmed whether overlapping ones are present among the first paths, and if so, the overlapping ones are integrated into a second path. It is confirmed whether concentric closed loops are present among the first paths, and if so, the concentric closed loops are integrated in to a spiral third path. The second path and the third path are connected into a final path.

In an embodiment of the disclosure, in the step in which the boundary of the processing area is equidistantly retracted at least once to obtain the first paths, each retracting distance is half of a processing width of a processing jig.

In an embodiment of the disclosure, in the step in which it is confirmed whether the overlapping ones are present among the first paths, adjacent two first paths whose distance therebetween is less than or equal to 0.01 mm are determined to be the overlapping ones.

To sum up, in the processing path generation method, the computer programming product, and the processing path generation system provided by the disclosure, the principle of path planning is provided, automatic generation is achieved after the computer loads the program, and that the production cycle is decreased.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a flow chart of a processing path generation method according to an embodiment of the disclosure.

FIG. 2A to FIG. 2C are schematic diagrams of an example of a processing path generated according to the processing path generation method of FIG. 1.

FIG. 3A to FIG. 3C are schematic diagrams of another example of a processing path generated according to the processing path generation method of FIG. 1.

FIG. 4A to FIG. 4C are schematic diagrams of still another example of a processing path generated according to the processing path generation method of FIG. 1.

FIG. 5A to FIG. 5C are schematic diagrams of yet another example of a processing path generated according to the processing path generation method of FIG. 1.

FIG. 6 is a flow chart of a processing path generation method according to another embodiment of the disclosure.

FIG. 7A and FIG. 7B respectively are examples of a processing path generated according to the processing path generation method of FIG. 1 and a processing path generated according to the related art.

FIG. 8A and FIG. 8B respectively are other examples of a processing path generated according to the processing path generation method of FIG. 1 and a processing path generated according to the related art.

FIG. 9A and FIG. 9B respectively are other examples of a processing path generated according to the processing path generation method of FIG. 1 and a processing path generated according to the related art.

FIG. 10 is a schematic diagram of a processing path generation system according to an embodiment of the disclosure.

### DESCRIPTION OF THE EMBODIMENTS

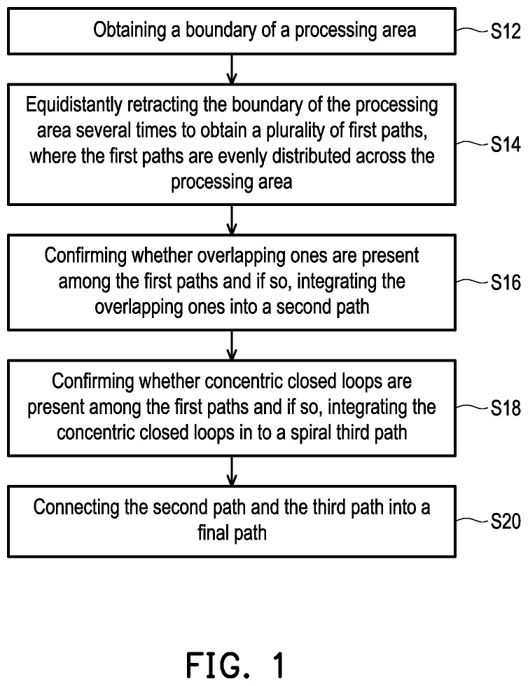

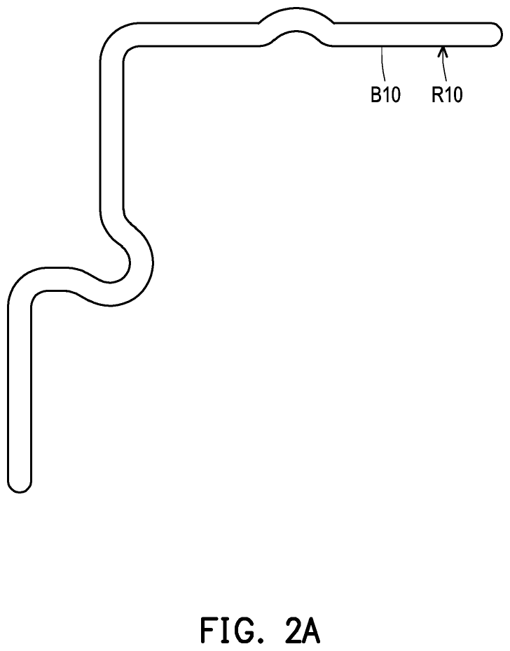

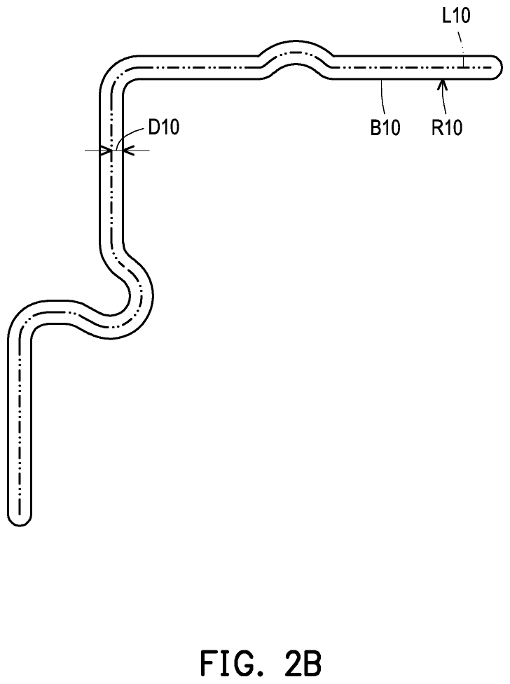

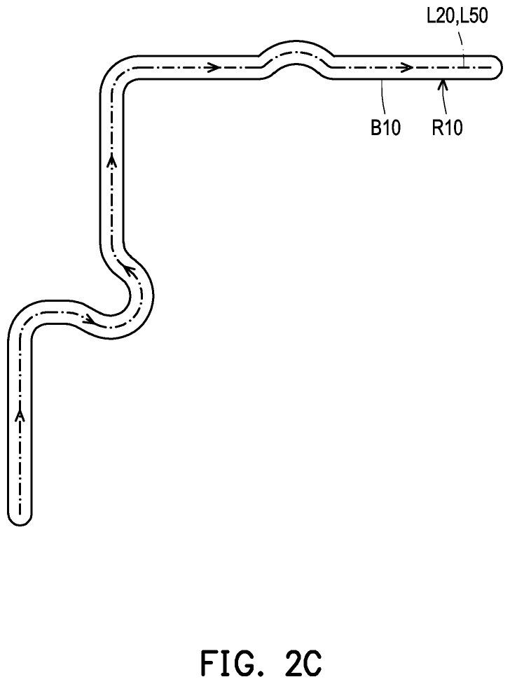

FIG. 1 is a flow chart of a processing path generation method according to an embodiment of the disclosure. FIG. 2A to FIG. 2C are schematic diagrams of an example of a processing path generated according to the processing path generation method of FIG. 1. The processing path generation method provided by this embodiment includes the following steps. With reference to FIG. 1 and FIG. 2A, first, a boundary B10 of a processing area R10 is obtained in step S12. With reference to FIG. 1 and FIG. 2B, next, the boundary B10 of the processing area R10 is equidistantly retracted at least once to obtain a plurality of first paths L10 in step S14.

The first paths L10 are evenly distributed across the processing area R10. With reference to FIG. 1 and FIG. 2C, it is then confirmed whether overlapping ones are present among the first paths L10, and if so, the overlapping ones are integrated into a second path L20 in step S16. In the embodiment of FIG. 2A, since a width of the processing area R10 is approximately equal to twice a retracting distance D10, so the first paths L10 formed after the boundary B10 on opposite sides of the processing area R10 is retracted substantially overlap. Therefore, only one first path L10 can be seen in FIG. 2B, but in fact, it is because the first paths L10 formed after the boundary B10 is retracted overlap. As described in step S16, the overlapping ones among the first paths L10 are integrated into the second path L20. To be specific, a portion of one first path L10 that overlaps another first path L10 is removed, and in this way, the remaining first paths L10 do not overlap each other, for example.

Next, it is confirmed whether concentric closed loops are present among the first paths L10, and if so, the concentric closed loops are integrated in to a spiral third path in step S18. In the embodiment of FIG. 2B, no concentric closed loop is present among the first path L10, and description of the presence of the concentric closed loops is provided in other embodiments in the following paragraphs. Finally, the second path L20 and the third path are connected into a final path L50 in step S20. In the embodiment of FIG. 2C, the third path and the unintegrated first paths L10 are not present, so the second path L20 is equivalent to the final path L50.

According to the description provided above, in the processing path generation method provided by this embodiment, the sequence of path planning is provided and the integrations of the overlapping paths and concentric closed loops are also provided, and automatic generation is achieved after a computer programming product that can execute this method is loaded into a system. In this way, the problem of working hour waste caused by manual path planning is prevented from occurring, no manual operation is required to pass on experiences, continuity of the paths is improved, less repeated paths are present, and less working hours are required.

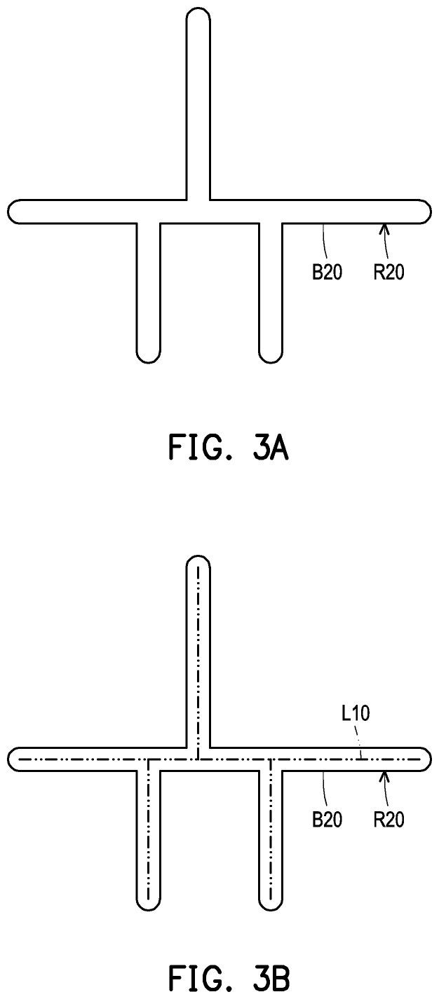

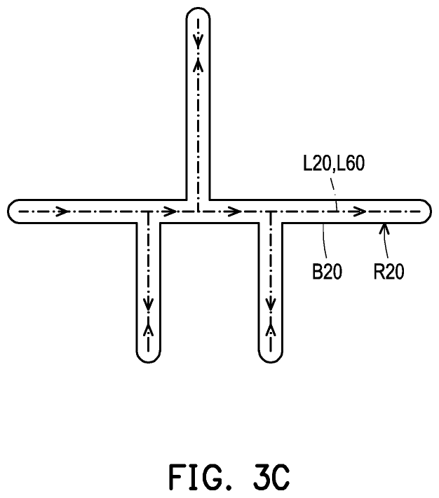

FIG. 3A to FIG. 3C are schematic diagrams of another example of a processing path generated according to the processing path generation method of FIG. 1. With reference to FIG. 3A, first, a boundary B20 of a processing area R20 is obtained. With reference to FIG. 3B, next, the boundary B20 of the processing area R20 is equidistantly retracted at least once to obtain a plurality of first paths L10. Next, with reference to FIG. 3C, since overlapping ones are present among the first paths L10, the overlapping ones are integrated into a second path L20. Therefore, no concentric closed loops are present among the first paths L10, so a third path is neither integrated nor formed. Finally, the second path L20 and the third path are connected into a final path L60. In the embodiment of FIG. 3C, the third path and the unintegrated first paths L10 are not present either, so the second path L20 is equivalent to the final path L60. Nevertheless, different from what is shown in FIG. 2C, in FIG. 3C, in order to make the final path L60 a continuous path so that the numbers of up and down movement and alignment performed by a processing jig is reduced, portions of the second path L20 are used twice in the final path L60, that is, the arrows move back when reaching the ends in FIG. 3C. In other embodiments, the second path L20, the third path, and the unintegrated first paths L10 may also be used more times to achieve the goal of path continuity. The arrows on the final path L60 in FIG. 3C indicate a moving direction of the processing jig.

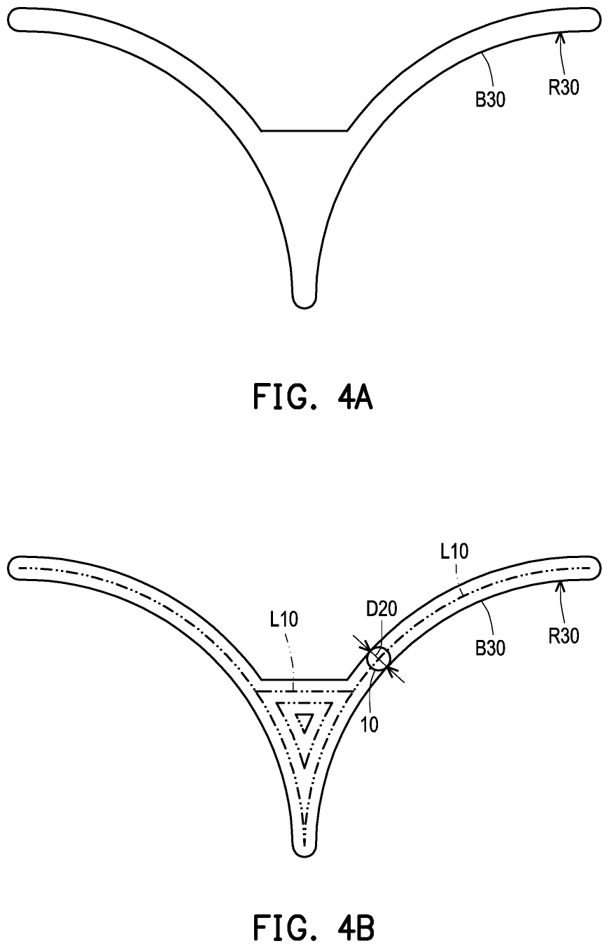

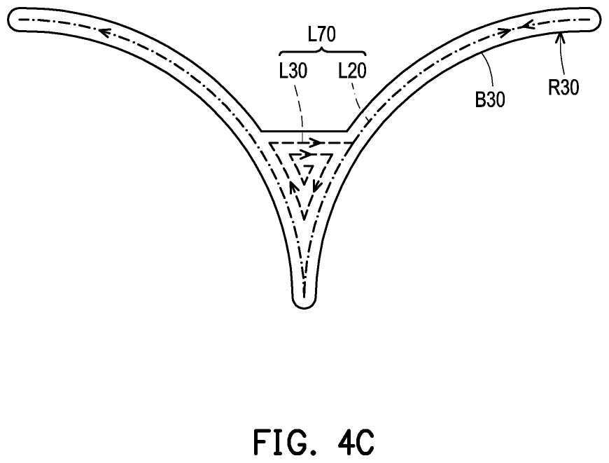

FIG. 4A to FIG. 4C are schematic diagrams of still another example of a processing path generated according to the processing path generation method of FIG. 1. With reference to FIG. 4A, first, a boundary B30 of a processing area R30 is obtained. With reference to FIG. 4B, next, the boundary B30 of the processing area R30 is equidistantly retracted at least once to obtain a plurality of first paths L10. In this embodiment, a middle portion of the processing area R30 is required to retract several times to obtain a plurality of first paths L10, so that the first paths L10 may be evenly distributed across the processing area R30. Next, with reference to FIG. 4C, since overlapping ones are present among the first paths L10, the overlapping ones are integrated into a second path L20. Besides, concentric closed loops are present among the first paths L10 in the middle portion of the processing area R30, the concentric closed loops are required to be integrated into a spiral third path L30. Finally, the second path L20 and the third path L30 are connected into a final path L70. In the embodiment of FIG. 4C, since the unintegrated first paths L10 are not present, the final path L70 is formed by the second path L20 and the third path L30.

In this embodiment, in the step in which the boundary B30 of the processing area R30 is equidistantly retracted at least once to obtain the first paths L10, each retracting distance D10 is half of a processing width D20 of a processing jig 10. In other embodiments, a ratio of the retracting distance D10 to the processing width D20 each time may also be greater or smaller, which is not particularly limited by the disclosure.

In this embodiment, in the step in which it is confirmed whether the overlapping ones are present among the first paths L10, adjacent two first paths L10 whose distance therebetween is less than or equal to 0.01 mm are determined to be the overlapping ones. When the distance between two first paths L10 is not 0 but the two first paths L10 are still determined to be the overlapping ones, a median of the two first paths L10 may be treated as the integrated second path L20.

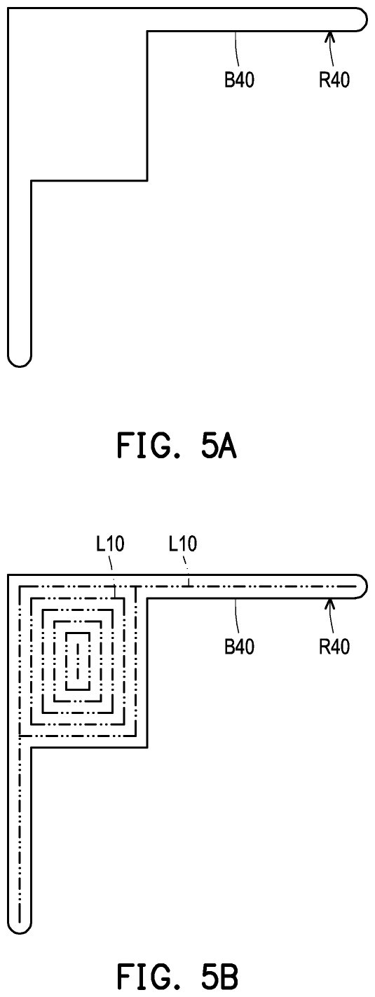

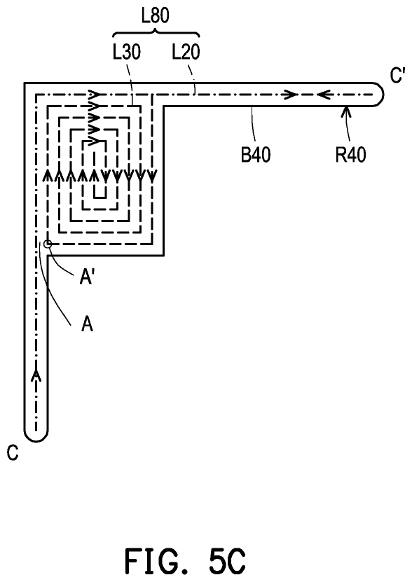

FIG. 5A to FIG. 5C are schematic diagrams of yet another example of a processing path generated according to the processing path generation method of FIG. 1. With reference to FIG. 5A, first, a boundary B40 of a processing area R40 is obtained. With reference to FIG. 5B, next, the boundary B40 of the processing area R40 is equidistantly retracted at least once to obtain a plurality of first paths L10. In this embodiment, a middle portion of the processing area R40 is required to retract several times to obtain a plurality of first paths L10, so that the first paths L10 may be evenly distributed across the processing area R40. Next, with reference to FIG. 5C, since overlapping ones are present among the first paths L10, the overlapping ones are integrated into a second path L20. Besides, concentric closed loops are present among the first paths L10 in the middle portion of the processing area R40, the concentric closed loops are required to be integrated into a spiral third path L30. Finally, the second path L20 and the third path L30 are connected into a final path L80. In the embodiment of FIG. 5C, since the unintegrated first paths L10 are not present, the final path L80 is formed by the second path L20 and the third path L30.

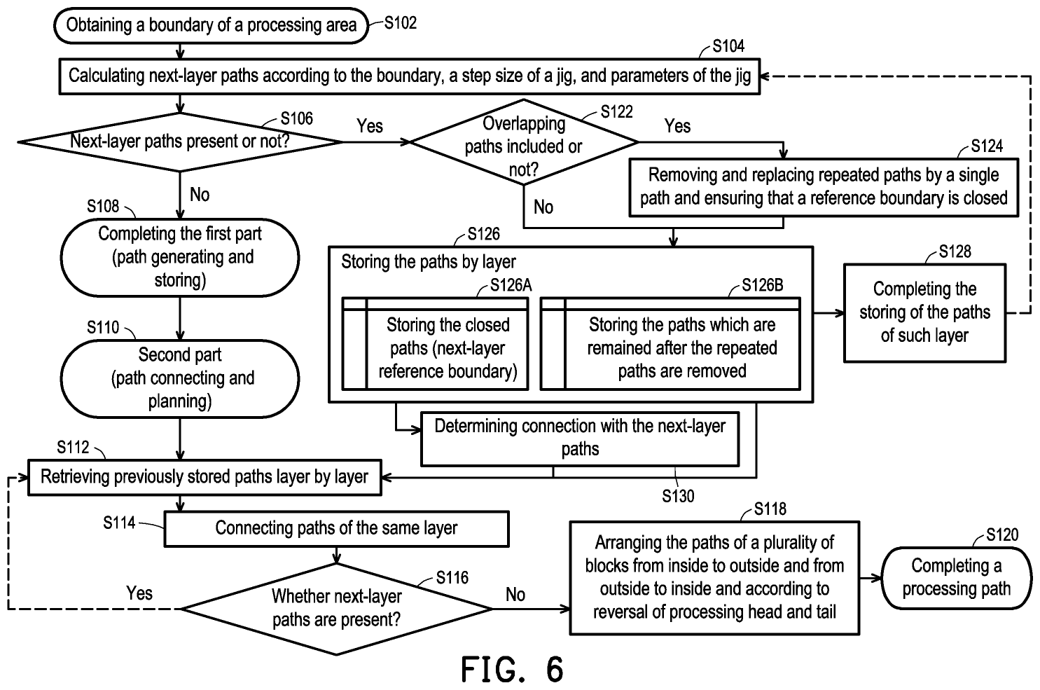

FIG. 6 is a flow chart of a processing path generation method according to another embodiment of the disclosure. With reference to FIG. 6, first, a boundary of a processing area is obtained in step S102. Next, first paths of a first layer are calculated according to the boundary, a step size of a jig, and some geometric parameters of the jig. That is, the boundary is retracted by a predetermined distance, and the first paths of the first layer are obtained in step S104. It is determined whether paths of the next layer are present, that is, whether the boundary may be equidistantly retracted again to obtain the first paths of the next layer in step S106. If the paths of the next layer are not present, the first part is completed, that is, all first paths are generated and stored in step S108. Next, the second part begins, and the paths are connected and planned in step S110.

In addition, in step S106, if it is determined that the paths of the next layer are present, it is determined whether overlapping first paths are included in step S122. If it is determined that the overlapping first paths are included, the overlapping first paths are integrated into a second path. That is, the repeated first paths are removed and are replaced by the second path, and it is ensured that the second path and the unintegrated first paths may form a closed path to act as a reference boundary for the next equidistant retracting in step S124. If it is determined that the overlapping first paths are not included, the first paths of this layer are directly stored in step S126. Further, after step S124 is completed, since the repeated first paths are removed and are replaced by the second path, in step S126 after step S124, only the second path is stored.

In step S126, the closed paths acting as the reference boundary for the next equidistant retracting are stored (step S126A), and the paths which are remained after the repeated paths are removed are also stored (step S126B). Next, storing of the paths of such layer is completed in step S128. Next, step S104 is performed again, the first paths of the next layer are calculated according to the boundary, the step size of the jig, and some geometric parameters of the jig. Besides, connection with next-layer paths is determined in step S130. FIG. 5B and FIG. 5C are used as examples for the explanation of step S130. In order to connect the third path L30 formed in a spiral shape, a connection process is required between each spiral shape and the next spiral shape. For instance, as shown in FIG. 5C, connection A′ with the next-layer paths is determined, and the overlapping section A which is processed before the connection is removed (A′ is treated as an example of connection herein, and the connection method is not limited thereto). In addition, the path of an outermost frame does not need to be processed. If the paths of each layer are calculated and stored, and no portion that needs to be determined to be connected is present, step S112 is performed. Similarly, step S112 is performed after step S110 is completed.

In step S112, the previously stored paths are retrieved layer by layer. Next, the paths of the same layer are connected in step S114. Herein, all paths are required to be used. A point that connects to the next layer is planned to be at the end of the path (for example, the connection point A′ illustrated in FIG. 5C), and the paths of unilateral connection are used first. Next, it is determined whether stored next-layer paths are still present in step S116. If yes is determined, steps S112 is performed again. If no is determined, step S118 is performed. The paths of a plurality of blocks are arranged from inside to outside (for example, starting from the center of FIG. 5C and going outwards along the path), from outside to inside (for example, starting from the position C or the position C′ in FIG. 5C and going inwards along the path, and implementation of FIG. 5C is performed based on the position C acting as the starting point as an example) and are arranged based on the principle of reversal of processing head and tail. Next, planning of a processing path is completed in step S120.

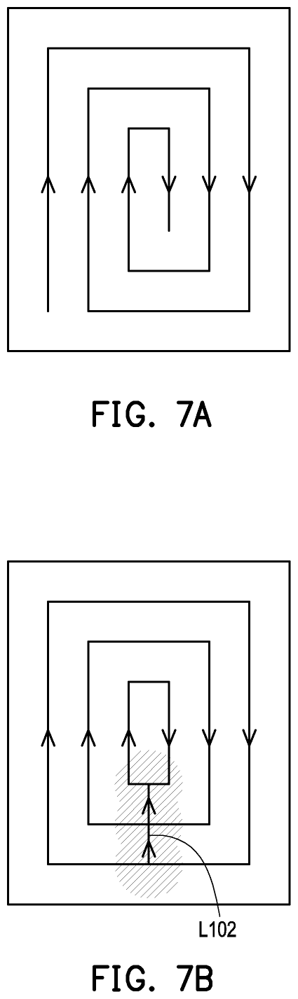

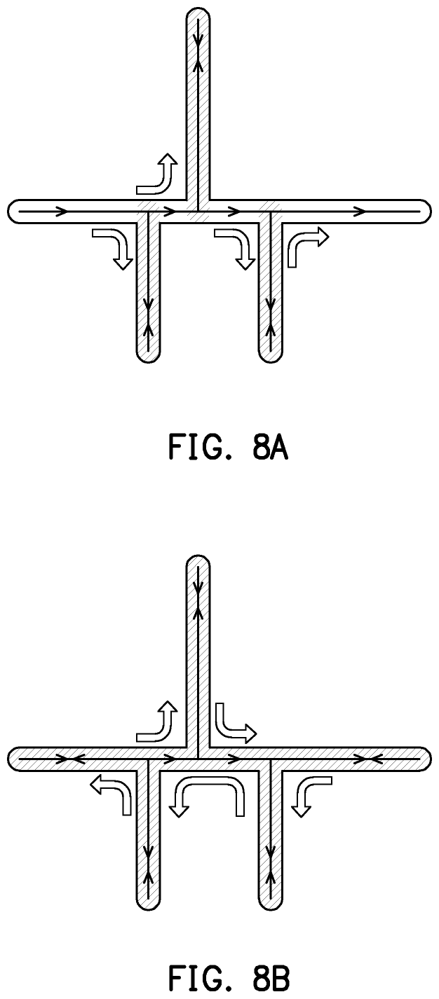

FIG. 7A and FIG. 7B respectively are examples of a processing path generated according to the processing path generation method of FIG. 1 and a processing path generated according to the related art. With reference to FIG. 7A and FIG. 7B, in the related art, the closed paths generated through equidistant retracting are directly connected to an external path L102. In contrast, a total length of the processing path generated according to the processing path generation method of FIG. 1 is shorter, and less working hours are required.

FIG. 8A and FIG. 8B respectively are other examples of a processing path generated according to the processing path generation method of FIG. 1 and a processing path generated according to the related art. With reference to FIG. 8A and FIG. 8B, in the related art, all paths generated through equidistant retracting are used to generate the final path, so the entire processing area is repeated. In contrast, only three among the processing paths generated according to the processing path generation method of FIG. 1 are repeated, the total length is shorter, and less working hours are required.

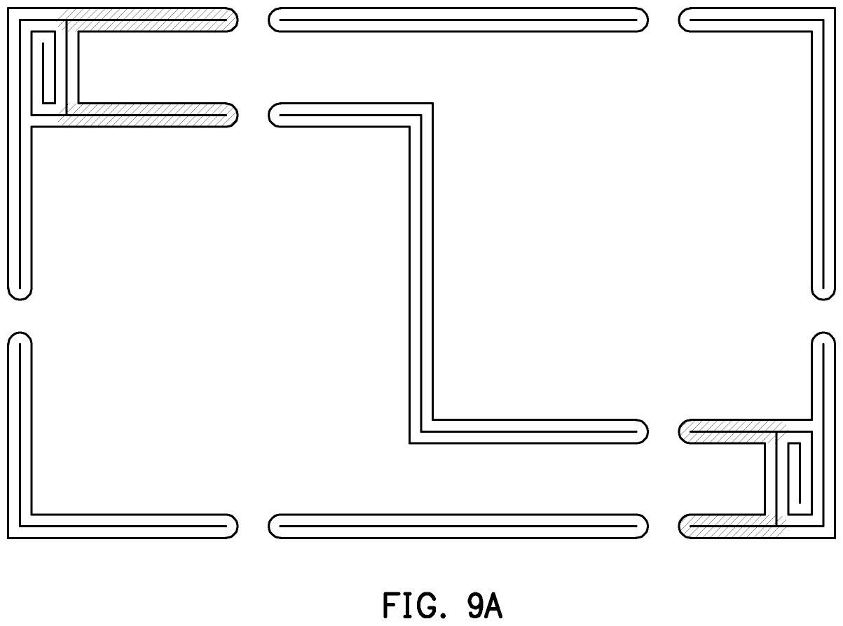

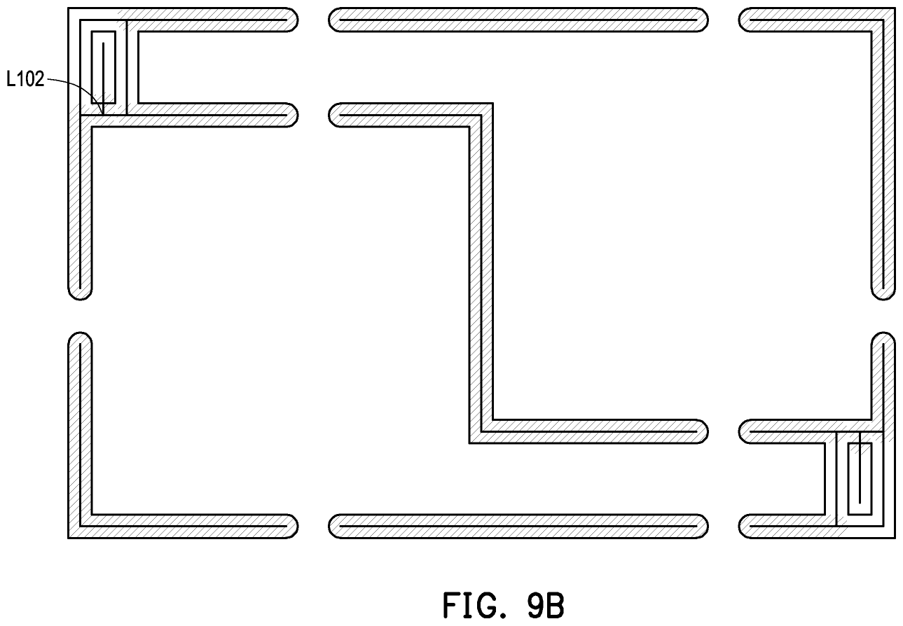

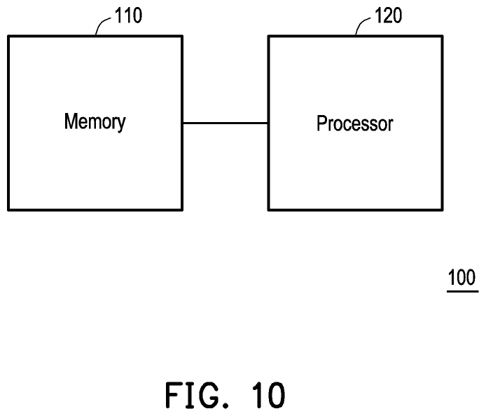

FIG. 9A and FIG. 9B respectively are other examples of a processing path generated according to the processing path generation method of FIG. 1 and a processing path generated according to the related art. With reference to FIG. 9A and FIG. 9B, in this embodiment, all paths generated through equidistant retracting are used to form the final path in the related art, and the closed paths generated through equidistant retracting are directly connected to the external path L102, so the paths are repeated considerably, and the total length reaches 732.82 mm. In contrast, only four among the processing paths generated according to the processing path generation method of FIG. 1 are repeated, the total length is reduced to 470 mm, and less working hours are required.

FIG. 10 is a schematic diagram of a processing path generation system according to an embodiment of the disclosure. With reference to FIG. 10, a processing path generation system 100 provided by this embodiment includes a memory 110 and a processor 120. The memory 110 is configured to store a program. The processor 120 is coupled to the memory 110 and is configured to execute the steps of the processing path generation method provided by the aforementioned embodiments after loading the program stored by the memory 110. Therefore, after a boundary of a processing area is inputted, a processing path may be automatically generated.

In the disclosure, a computer programming product is also provided. The steps of the processing path generation method may be executed after a computer loads the program. The computer programming product includes a plurality of programming instructions. After the processor in the processing path generation system loads and executes these programming instructions, the processing path generation method may be completed, and the functions of the processing path generation system may be implemented.

In view of the foregoing, in the processing path generation method, the computer programming product, and the processing path generation system provided by the disclosure, the overlapping paths are integrated into a single path, the concentric closed loops are also integrated into a spiral path, and automatic generation is achieved after the computer loads the program. Therefore, the paths are not required to be manually planned, the time for path planning and processing may be saved, and the production cycle is reduced.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A processing path generation method, comprising:
obtaining a boundary of a processing area;
equidistantly retracting the boundary of the processing area at least once to obtain a plurality of first paths, wherein the first paths are evenly distributed across the processing area;
confirming whether overlapping ones are present among the first paths and if so, integrating the overlapping ones into a second path;
confirming whether concentric closed loops are present among the first paths and if so, integrating the concentric closed loops in to a spiral third path; and
connecting the second path and the third path into a final path.

2. The processing path generation method according to claim 1, wherein in the step of equidistantly retracting the boundary of the processing area at least once to obtain the first paths, each retracting distance is half of a processing width of a processing jig.

3. The processing path generation method according to claim 2, wherein in the step of confirming whether overlapping ones are present among the first paths, the first paths whose distance therebetween is less than or equal to 0.01 mm are determined to be the overlapping ones.

4. A computer programming product, wherein after a program is loaded through a computer, the computer programming product is configured to perform the following steps:
obtaining a boundary of a processing area;
equidistantly retracting the boundary of the processing area at least once to obtain a plurality of first paths, wherein the first paths are evenly distributed across the processing area;
confirming whether overlapping ones are present among the first paths and if so, integrating the overlapping ones into a second path;
confirming whether concentric closed loops are present among the first paths and if so, integrating the concentric closed loops in to a spiral third path; and
connecting the second path and the third path into a final path.

5. The computer programming product according to claim 4, wherein in the step of equidistantly retracting the boundary of the processing area at least once to obtain the first paths, each retracting distance is half of a processing width of a processing jig.

6. The computer programming product according to claim 4, wherein in the step of confirming whether overlapping ones are present among the first paths, the first paths whose distance therebetween is less than or equal to 0.01 mm are determined to be the overlapping ones.

7. A processing path generation system, comprising:
a memory, configured to store a program; and
a processor, coupled to the memory, configured to load the program to execute the following steps:
obtaining a boundary of a processing area;
equidistantly retracting the boundary of the processing area at least once to obtain a plurality of first paths, wherein the first paths are evenly distributed across the processing area;
confirming whether overlapping ones are present among the first paths and if so, integrating the overlapping ones into a second path;
confirming whether concentric closed loops are present among the first paths and if so, integrating the concentric closed loops in to a spiral third path; and
connecting the second path and the third path into a final path.

8. The processing path generation system according to claim 7, wherein in the step of equidistantly retracting the boundary of the processing area at least once to obtain the first paths, each retracting distance is half of a processing width of a processing jig.

9. The processing path generation system according to claim 7, wherein in the step of confirming whether overlapping ones are present among the first paths, the first paths whose distance therebetween is less than or equal to 0.01 mm are determined to be the overlapping ones.
